(19) United States
(12) Patent Application Publication
(10) Pub. No.: US 2006/0250951 A1
(43) Pub. Date: Nov. 9, 2006

(54) Path switching system for network

(76) Inventors: Koji Ueda, Osaka (JP); Kazuhiro Nakashima, Fukuoka (JP); Hirofumi Mitome, Fukuoka (JP); Tetsuya Uehori, Kawasaki (JP); Masayoshi Nakano, Fukuoka (JP)

Correspondence Address: KATTEN MUCHIN ROSENMAN LLP, 575 MADISON AVENUE, NEW YORK, NY, 10022-2585, US

(21) Appl. No.: 11/449,038

(22) Filed: Jun. 7, 2006

Related U.S. Application Data
(63) Continuation of application No. PCT/JP03/16006, filed on Dec. 12, 2003.

(51) Int. Cl. H04J 3/14

(52) U.S. Cl. 370/217; 379/93.37; 379/1.01

(57) ABSTRACT

A path switching system can dramatically decrease time required until a transfer path of user data is switched to a detour path when a failure occurred to a system/line constituting the network. In the path switching system, a path is set by a switch device and a plurality of relay devices adjacent to the switch device, and the switch device has a notification processing section notifying information to specify a corresponding relay device to the plurality of other relay devices when a failure of an adjacent relay device or a line failure between adjacent relay devices is detected, and the relay device has a path change processing section canceling information on the path that passes through the relay device detected to have a failure, from the information notified by the notification processing section of the relay device.

### CROSS REFERENCE TO RELATED APPLICATIONS

This application is a continuation of International Application No. PCT/JP2003/016006, filed on Dec. 12, 2003, now pending, herein incorporated by reference.

### TECHNICAL FIELD

The present invention relates to a path switching for a network, and more particularly to a path switching system for a network where a transfer path of user data is dynamically switched when a failure occurs.

### BACKGROUND ART

In an IP (Internet Protocol) network comprised of a plurality of relay devices (router devices), a path management function (automatic path recognition, automatic path recognition when the configuration is changed), and dynamic routing protocol (RIP: Routing Information Protocol, OSPF: Open Shortest Path First) as the path failure detection function are used.

In this system, reliability of the paths is dynamically confirmed by detecting the path failure/device failure between the relay devices (router devices) using the packets specified by each protocol. If a line failure/device failure is detected, the path information (a table storing the shortest route by an algorithm specified by the protocol) is updated, and dynamic switching to detour is implemented.

Recently VPN (Virtual Private Network) is often constructed on the IP (Internet Protocol) network. As a VPN (Virtual Private Network) technology, MPLS-VPN (Multi-Protocol Label Swithing-Virtual Private Network), which creates a tunnel by LSP (Label Swithing Path), is widely used, but LDP/RSVP-TE (Link Disconnect Protocol/Resource Reservation Protocol) represented by this LSP connection protocol also uses a method for detecting the path failure between relay devices.

However with Ethernet, which is a typical line type on an IP network, relay devices are generally connected via a switch (SW) device, and in this connection format, a unit for detecting the line failure between one relay device and the switch device (a unit equivalent to OAM (Operation, Administration and Maintenance) provided to the ATM line) is not provided to the other relay device connected via the SW device.

Therefore the path information is updated or the LSP is switched when the timer specified by the dynamic routing protocol has elapsed.

The format of connecting the relay devices via the switch device is mostly the point-to-multi-point format, so a failure in an arbitrary relay device must be notified to a plurality of relay devices. A relay device which receives the notice, on the other hand, must specify the failed relay device out of the plurality of connected relay devices.

As described above, prior art has no function to notify the line failure or device failure between an arbitrary switch device and a relay device to another relay device when the relay devices are connected via the switch device.

Particularly because of the point-to-multi-point connection format, the notification function to specify the failed relay device is not available.

Therefore an update of path information or the switching of the LSP cannot be performed until the timer, specified by the dynamic routing protocol, elapses, and communication between users is disconnected during this time.

Although the speed of the update of the path information or the switching of the LSP can be increased by setting the timer specified by the dynamic routing protocol to be a shorter time, this makes the load on the network and the load on the relay devices (router devices) constituting the network constantly high, which makes it difficult to construct an efficient network.

In this way, the point-to-multi-point format network using Ethernet, which is a typical line type on an IP network, has problems in terms of reliability and speed.

A prior art to decrease the communication interrupt time when a path on a network is switched has been proposed (Japanese Patent Application Laid-Open No. 2002-374288). The method disclosed in this document is characterized in that an output destination network is decided for an IP packet relayed to a failed network, then the path is selected again.

Other technologies on path switching when a failure occurs are known (Japanese Patent Application Laid-Open No. 2002-281068, and No. H11-284633). In these technologies, the relationship of a router and a switch device is not mentioned.

### DISCLOSURE OF THE INVENTION

With the foregoing in view, it is an object of the present invention to dramatically decrease the time until the transfer path of the user data is switched to the detour path when a system/line failure occurred in the network constituting a point-to-multi-point format IP network using Ethernet.

A first aspect of the path switching system for a network to achieve the object of the present invention is a path switching system for a point-to-multi-point format IP network using Ethernet where a path is set by a switch device and a plurality of relay devices adjacent to the switch device, characterized in that the switch device has a notification processing section for notifying information to specify a corresponding relay device to a plurality of other relay devices when a failure of an adjacent relay device or a line failure between adjacent relay devices is detected, and the relay device has a path change processing section for canceling information on the path that passes through the relay device detected to have a failure, out of the information notified by the notification processing section of the relay device.

A second aspect of the path switching system for a network to achieve the object of the present invention is the first aspect characterized in that the notification processing section of the switch device notifies the failure to a plurality of adjacent relay devices using broadcast packets.

A third aspect of the path switching system for a network to achieve the object of the present invention is the first aspect, characterized in that the path change processing section of the relay device cancels only information on the path that passes through a specific relay device notified by the notification processing section of the switch device out of a plurality of path information dynamically recognized/acquired by the dynamic routing protocol.

A fourth aspect of the path switching system for a network to achieve the object of the present invention is the first aspect, characterized in that the switch device uses a MAC address of a relay device as the information to specify the corresponding relay device when a failure of an adjacent relay device or a line failure between adjacent relay device is detected, and a path change processing section of the relay device searches a table indicating the correspondence of the MAC address and the IP address using the MAC address, and recognizes the IP address of the corresponding relay device.

A fifth aspect of the path switching system for a network to achieve the object of the present invention is the first aspect, characterized in that the relay device has a label switching path detection section and a routing detection section, and when only information on the path that passes through a specific relay device notified by the notification processing section of the switch device is cancelled out of a plurality of path information dynamically recognized/acquired by the dynamic routing protocol, the path change processing section of the relay device sends a notice to the label switching path detection section and the routing detection section, and cancels the information on paths to a plurality of adjacent relay devices out of the label switching path information and a routing table mapped by the label switching path detection section, and routing detection section respectively.

The characteristics of the present invention will be further clarified by the embodiments to be described with reference to the drawings.

### BRIEF DESCRIPTION OF THE DRAWINGS

FIG. 1 is a diagram depicting a configuration example of a network that has a point-to-multi-point connection format via Ethernet lines comprising a detour path;

FIG. 2 is a diagram depicting the generation of failure X in FIG. 1;

FIG. 3 is a diagram depicting the detour circuit creation in FIG. 1;

FIG. 4 is a conceptual diagram depicting the network path switching method according to the present invention in the configuration corresponding to FIG. 2;

FIG. 5 is a diagram depicting the configuration of the switch device 10 of the router device and of the router device 20 for implementing the network path switching method of the present invention;.

FIG. 6 is a diagram depicting the relationship of the switch device 10 and the router device 20 in FIG. 5 corresponding to the connection between the router device D and the switch device SW1 in the network configuration in FIG. 4;

FIG. 7 is a flow chart depicting the operation of the line failure detection section 120 of the switch device 10;

FIG. 8 is a flow chart depicting the operation of the line status monitoring section 130;

FIG. 9 is a flow chart depicting the notification processing section 140 of the switch device;

FIG. 10 is a flow chart depicting the path change processing section 200 of the router device 20;

FIG. 11 is a table explaining an example of the ARP protocol format;

FIG. 12 is a table explaining the operation code in FIG. 11;

FIG. 13 is a diagram depicting the second embodiment;

FIG. 14 is a diagram depicting the contents of the LSP path table 240; and

FIG. 15 is a diagram comparing the conventional path switching operation (FIG. 15A) and the path switching operation according to the present invention (FIG. 15B).

### BEST MODE FOR CARRYING OUT THE INVENTION

Embodiments of the present invention will be described with reference to the drawings, but prior to this the problems of the conventional configuration will be described to more thoroughly understand the present invention.

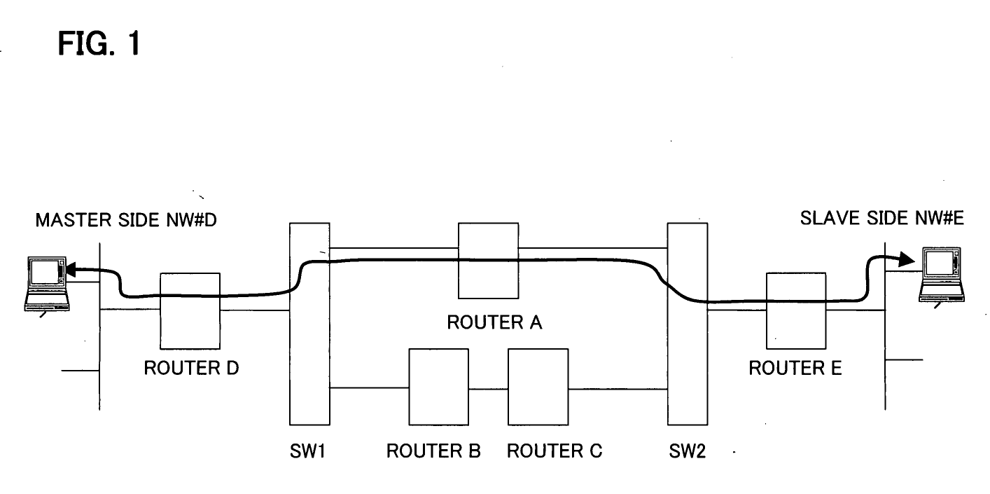

FIG. 1 shows a configuration example of a network that has the point-to-multi-point connection format via Ethernet lines described above, where a detour path is provided.

In the case of the network where a plurality of relay devices (router devices) A-E and a plurality of SW devices 1 and 2 coexist, if communication is performed between the network NW#D under the router device D and the network NW#E under the router device E, a redundant configuration is possible by selecting one of two paths, the path of NW#D→router device D→SW1→router device A→SW2→router device E→NW#E, and the path of NW#D→router device D→SW1→router device B→router device C→SW2→router device E→NW#E.

Here it is assumed that the path via the router device A is selected with priority in terms of the metrics, as shown in FIG. 1.

In the configuration in FIG. 1, failure of each point of the point-to-multi-point configuration (router devices A, B and D connected via the first switch device SW1, or the router devices A, C and E connected via the second switch device SW2) is detected and is notified.

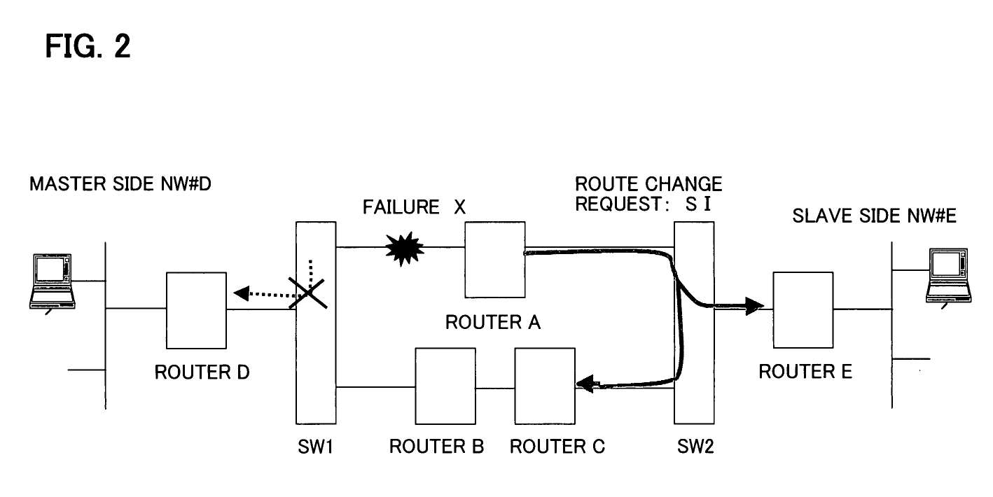

In this configuration, if a failure occurs to the point X, as shown in FIG. 2, when data is sent from the terminal (master side terminal) connected to the master side network NW#D to the terminal (slave side terminal) connected to the slave side network NW#E via the router device A, the router device A detects the failure. In this case, the router device A detects the failure and sends a route change request to the router device E and the router device C via the second switch device SW2 (step SI).

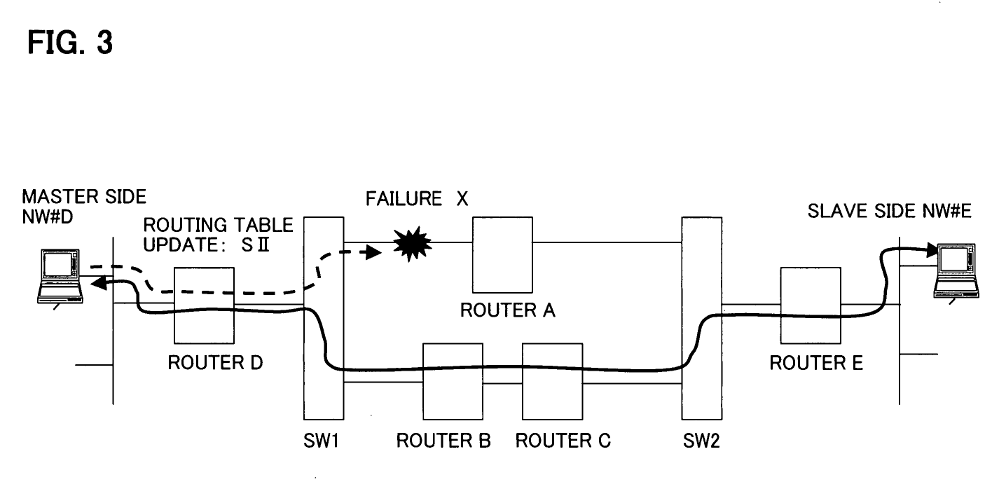

In this case, the generation of the failure can also be detected by the first switch device SW1, but the conventional system has no function to detect this failure and notify it. Therefore in such a case, the router device D is monitoring the timer, as shown in FIG. 3, and the routing table is updated when the timer expires, then the route can be changed (step SII). However several tens of seconds to several minutes of time is required until the time expires.

In this way, in the case of the conventional network path switching method, a high-speed switching speed cannot be implemented. With the foregoing in view, the present invention provides a network path switching method and device that solves the above problem.

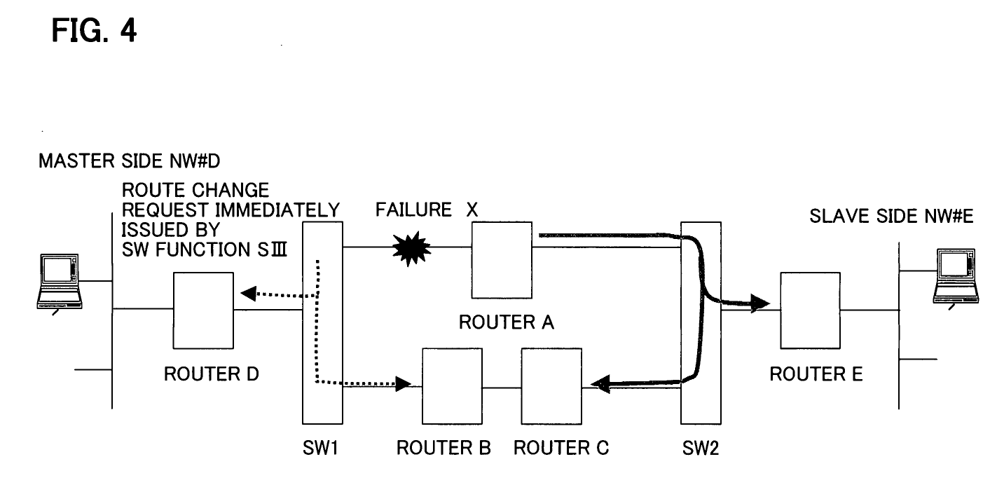

FIG. 4 is a conceptual diagram depicting the path switching method for a network according to the present invention used in a configuration corresponding to FIG. 2.

A characteristic of the present invention is that the switch device SW1 has a failure notification function. In other words, when the switch device SW1 detects a failure using the failure notification function thereof, the switch device SW1 notifies the failure via the port connected to the active line of the switch device SW1.

The switch device SW1 also notifies the failure to the router device D. By this, the router device D can update the path information of the routing table without waiting for expiration of the timer, and can request a route change immediately (step SIII).

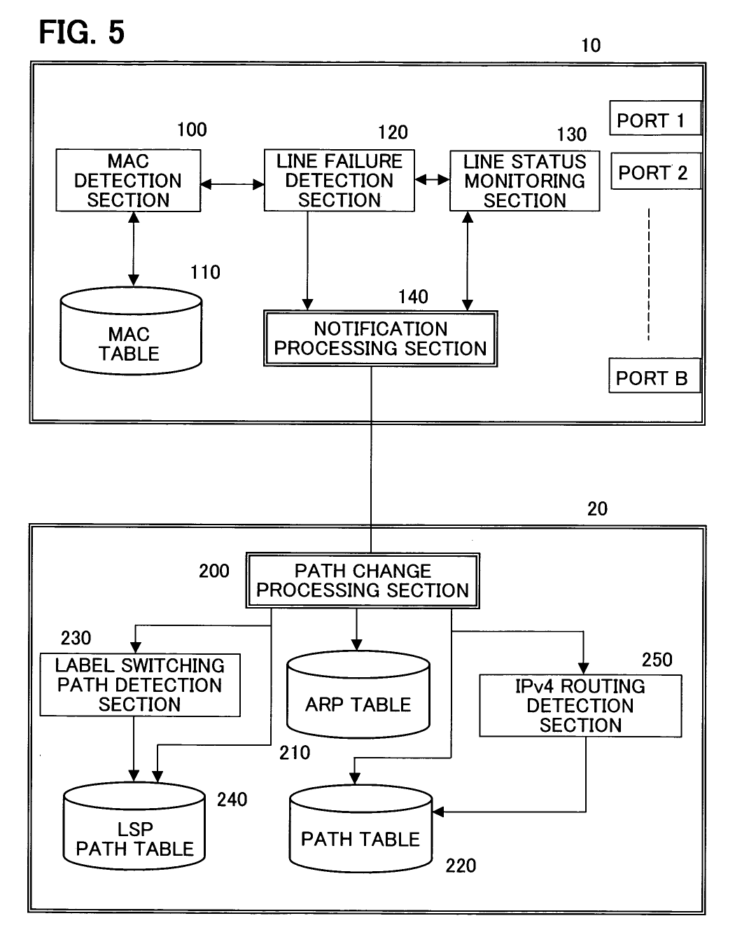

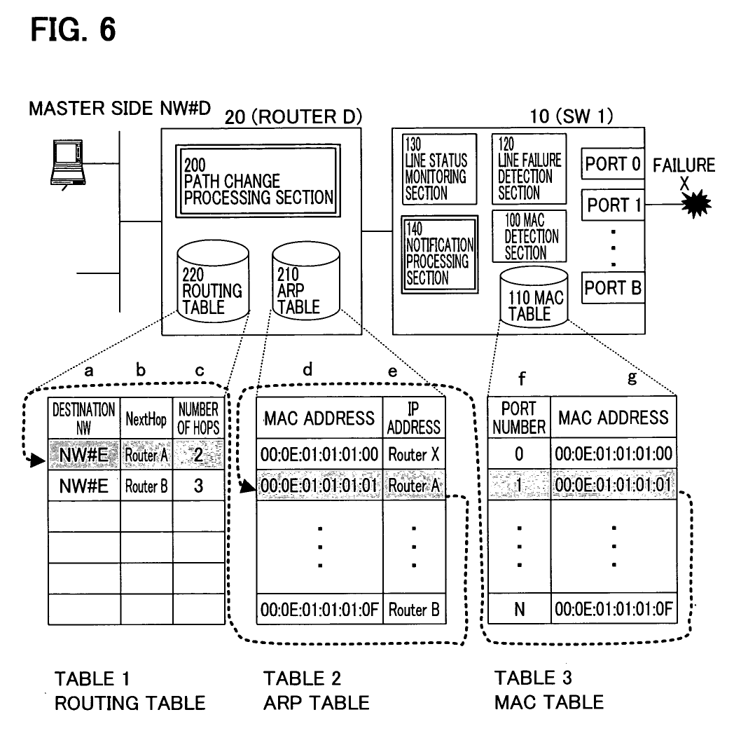

FIG. 5 shows the configuration of the switch device 10 and the router deice 20 for implementing the path switching method for a network according to the present invention. FIG. 6 shows the relationship of the switch device 10 and the router device 20 in FIG. 5 corresponding to the connection of the router device D and the switch device SW1 in the network configuration in FIG. 4.

As described in FIG. 1, in FIG. 4 as well, if communication is performed between the network NW#D under the router device D and the network NW#E under the router device E, redundancy is taken by two paths, the path of NW#D→router device D→SW1→router device A→SW2→router device E→NW#E, and the path of NW#D→router deice D→SW1→router device B→router device C→SW2→router device E→NW#E.

Here according to the present invention, the router device 20 (router device D in FIG. 4) has a routing (path) table 220 that indicates the relationship of the destination network a, the router device b to be the path, and the number of hops c, as shown in Table 1 in FIG. 6. The router device 20 also has the ARP (Address Resolution Protocol) Table 210 shown in Table 2 in FIG. 6, which indicates the IP address e corresponding to the MAC address d of each router device.

The switch device 10 (SW1 in FIG. 4), on the other hand, has the MAC table 110 shown in Table 3 in FIG. 6, which indicates the MAC address g corresponding to the port number f.

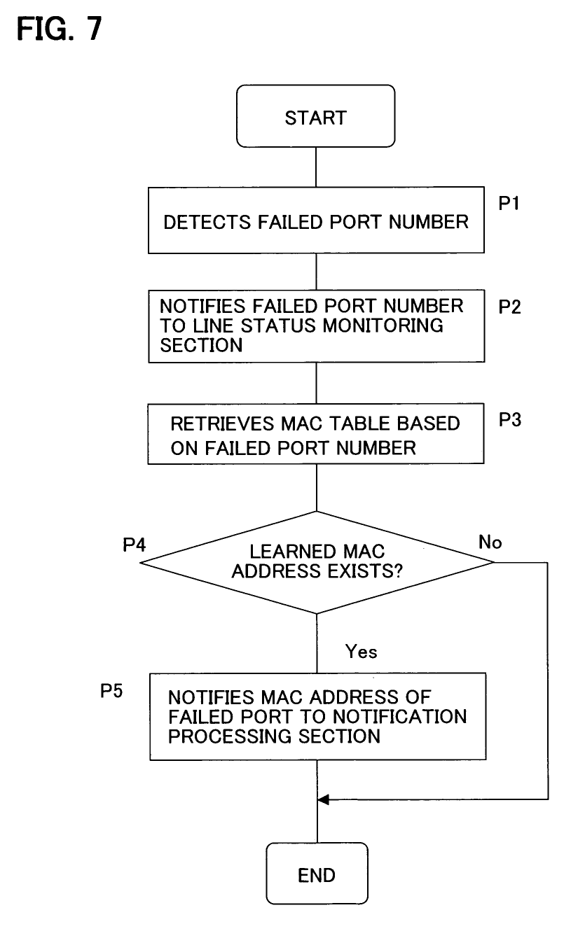

This path switching method for a network according to the present invention based on the switch device 10 and the router device 20 in the configuration shown in FIG. 5 will be described according to the operation flows in FIG. 7 to FIG. 10.

FIG. 7 shows the operation flow of the line failure detection section 120 of the switch device 10. The line failure detection section 120 constantly detects the signal level, and detects the port number where the failure occurred in the physical layer (processing step P1).

For example, if failure X occurred to the line between the router device 20 and the switch device 10, or the device failure occurred to the router device A in FIG. 4, the line failure detection section 120 of the switch device SW1 detects the failure of the line (port) connected with the router device A on the physical layer.

The port number where the failure was detected by the line failure detection section 120 is notified to the line status monitoring section 130 (processing step P2). In the example in FIG. 4, the line failure detection section 120 of the switch device SW1 notifies the number (port number) of the line connected to the router device A to the line status monitoring section 130.

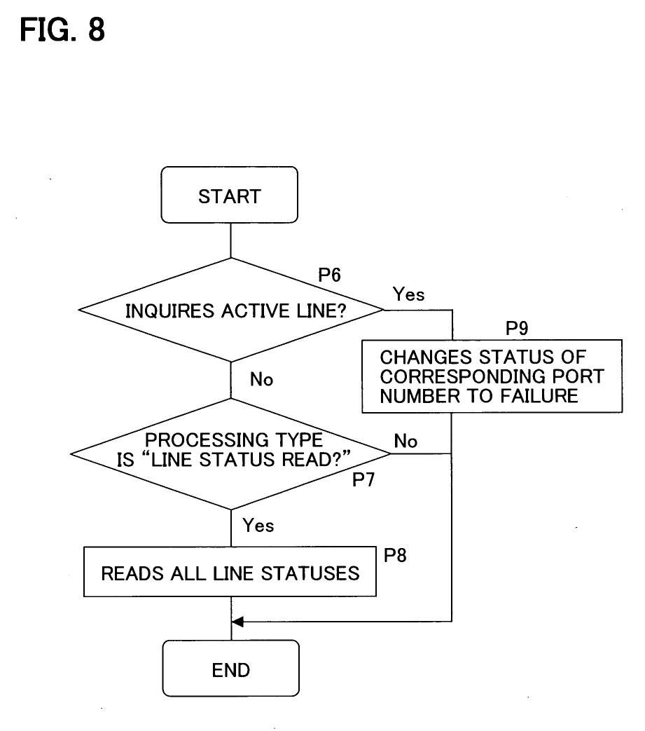

FIG. 8 shows the operation flow of the line status monitoring section 130, where the line status monitoring section 130 manages the status of all the lines that the switch device 10 has. In other words, if the processing type in the line status monitoring section 130 is not line status change (processing step P6, NO), but line read status (processing step P7, YES), all the line statuses are read (processing step P9).

If a failure of the line connected with the router device 20 is notified from the line failure detection section 120, on the other hand, it is judged that the processing type is line status change (processing step P6, YES), and the status of the corresponding port number is changed from active status to failed status (processing step P9).

In the operation flow of the line failure detection section 120 in FIG. 7, the line failure detection section 120 of the switch device 10 retrieves the MAC table 110 in the switch device 10 using the number (port number) of the line connected with the router device 20 as the retrieval condition (processing step P3), and acquires the MAC address learned between the switch device 10 and the router device 20 (processing step P4, YES). By this, a MAC address corresponding to the port number where the failure occurred can be acquired.

Here the switch device 10 has a function (learning function) for remembering the MAC address of the transmission source using the MAC detection section 100 in the switch device 10, so that the frames transmitted by the device connected to the switch device 10 (e.g. router device) and the terminal are relayed by the switch device 10.

For this, the switch device has a function to manage the MAC address of the frame transmission source and the corresponding port number connected thereto on the MAC table 110 (see Table 3 in FIG. 6), as described in FIG. 6.

Therefore the MAC address, which the line failure detection section 120 of the switch device 10 acquires from the MAC table 110 using the port number as the retrieval condition when the line/device failure occurred between the router device 20 and the switch device 10, is the MAC address of the router A in the example in FIG. 4.

If the MAC address to be retrieved exists (processing step P4, YES) in this way, then the acquired MAC address information of the router device A is sent to the notification processing section 140 of the switch device 10, which was attached to implement the present invention (processing step P5).

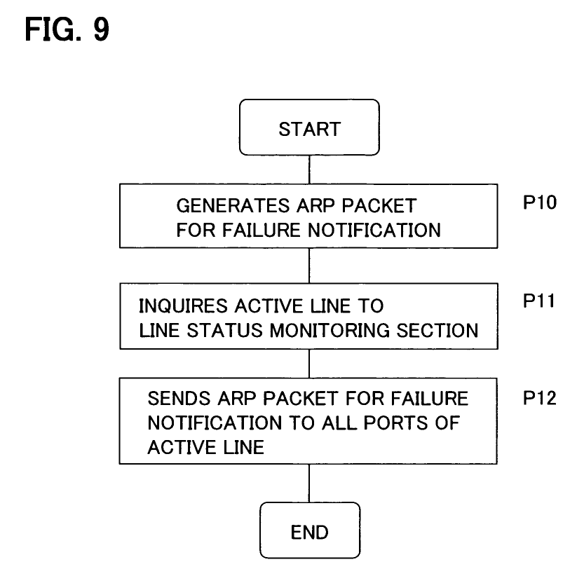

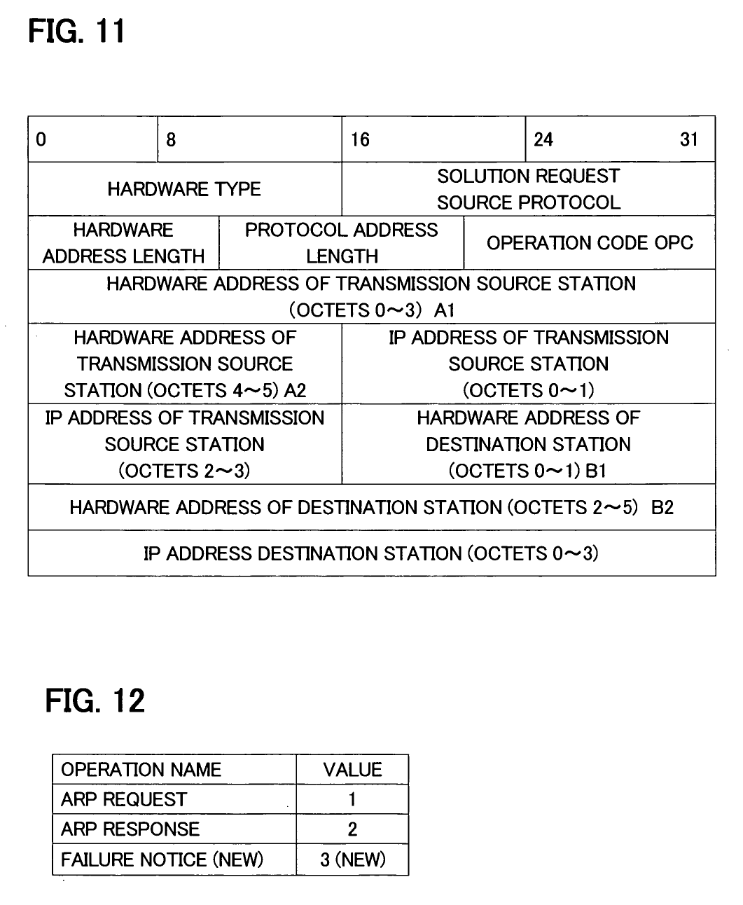

The notification processing section 140 of the switch device 10 generates the ARP packet using the ARP protocol format shown in FIG. 11 according to the operation flow in FIG. 9 (processing step P10).

At this time, the MAC address of the router device A notified from the line failure detection section 120 is stored in the hardware address position (A1, A2) of the transmission source station, and the address of all “Fs”, which indicates the broadcast frame, is stored in the hardware address position (B1, B2) of the destination station.

Also as FIG. 12 shows, the unused bit “3” of the operation code (C) is used as the value for failure notification which is required for the present invention, and the above value is set by the notification processing section 140 of the switch device 10.

In this way, when the ARP packet is generated by the notification processing section 140 (processing step P10), the line status monitoring section 130 of the switching device 10 is inquired, and the port number of the line in active status is acquired (processing step P11).

The notification processing section 140 sends the ARP packet for notifying the failure to all the port numbers of the lines in active status which are acquired from the result of the inquiry to the line status monitoring section 130 (processing step P12).

By this, in the network in FIG. 4, the ARP packet for failure notification storing the MAC address of the router device A is notified to the router device B and the router device D.

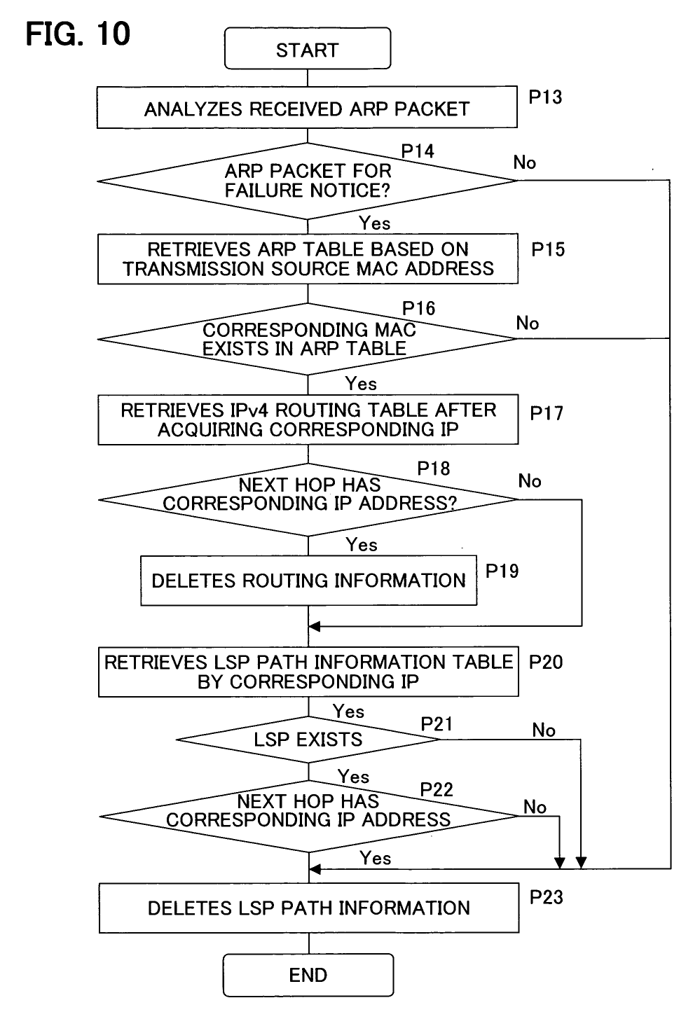

FIG. 10 is an operation flow of the path change processing section 200 of the router device 20 (common to router device B and router device D in the example of the network in FIG. 4). In the following description, the corresponding router device is specified only when necessary.

The router device 20 analyzes the ARP packet in FIG. 11 received from the switch device 10 (SW1) in the path change processing section 200 (processing step P13). In this analysis, if the operation code (FIG. 11: OPC) is the failure notice (see FIG. 12) (processing step P14, YES), the ARP table 210 (FIG. 6: Table 2) in the router device 20 is retrieved using the transmission source MAC address in the notified ARP packet as the retrieval condition (processing step P15).

In this retrieval, the IP address corresponding to this MAC address is acquired (process step P16, YES).

In the router device 20, when the IP packet is relayed to a device, such as a router device, and a connection destination with the router device 20, that is a terminal, the MAC address must be attached to the connection destination information in the IP packet.

For this, the router device 20 has a function to correspond the IP address of the connection destination and the MAC address, and manage them on the ARP table 210 using the path change processing section 200 (see Table 2 in FIG. 6).

Therefore in the router device 20 (B, D), the routing (path) table 220 is retrieved by the IP address acquired based on the transmission source MAC address (hardware address A1, A2) in the ARP packet for failure notification (processing step P17). By this, it is recognized that the acquired IP address is the IP address of the router device A.

At this point, the router device 20 (B, D) can recognize that a failure occurred to a line to the router device A.

After the path change processing section 200 of the router device 20 (B, D) recognized that the line to the router device 20 (A) failed, the routing detection section 250 retrieves the NextHop (adjacent) router device (b) in the routing table 220 (FIG. 6, Table 1) using the IP address of the router device 20 (A) as the retrieval condition (processing step P18).

If a corresponding path information exists (processing step P18, YES), this path information is deleted from the routing table 220 (processing step P19).

As a conventional function, the routing detection section 250 in the router device 20 acquires the NextHop router device (FIG. 6, Table 1b) corresponding to the destination network NW by referring to the routing table 220 when the IP packet is relayed to the destination network NW. Then the IP packet is sent to the acquired adjacent router device.

Therefore in the router device 20 (B, D), the path information, of which adjacent router device is the router device 20 (A), is deleted (processing step P19), and from this point on, the IP packets, which used to pass through the router device 20 (A) for communication, all pass through the detour path (path via the router device B and the router device C), and communication can be performed immediately.

After the path change processing section 200 in the router device 20 (B, D) recognized that the line to the router device 20 (A) failed, if the LSP path has been set in the LSP path table 240 (processing step P21, YES), the adjacent router device in the LSP path table 240 is retrieved by the label switching path detection section 230 using the IP address of the router device 20 (A) as the retrieval condition. (processing step P22), and if a corresponding path information exists (processing step P22, YES), this is deleted (processing step P23).

Therefore in the router device 20 (B, D), the LSP path information, of which adjacent router device is the router device A, is deleted, and from this point on, the packets which used to pass through the router device A for communication, all pass through the detour circuit (path via the router device 20 (B, C)), and communication can be performed immediately.

If the router device 20 functions as a label switch router device here, a switch operation is performed according to the mapping data of the LSP path table 240 using the information (label) of the lower layer of the IP address.

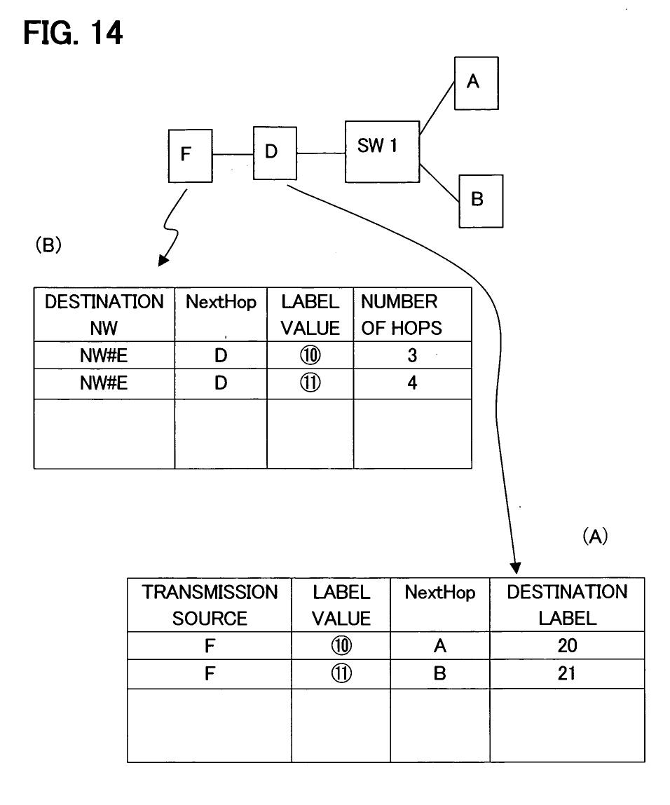

The content of the LSP path table 240 will be described using the example shown in FIG. 14. In FIG. 14, (A) is the LSP mapping data mapped on the LSP path table 240 in the router device D. The data transmission source router device, label value, NextHop (adjacent router device) and label of the destination router device are registered.

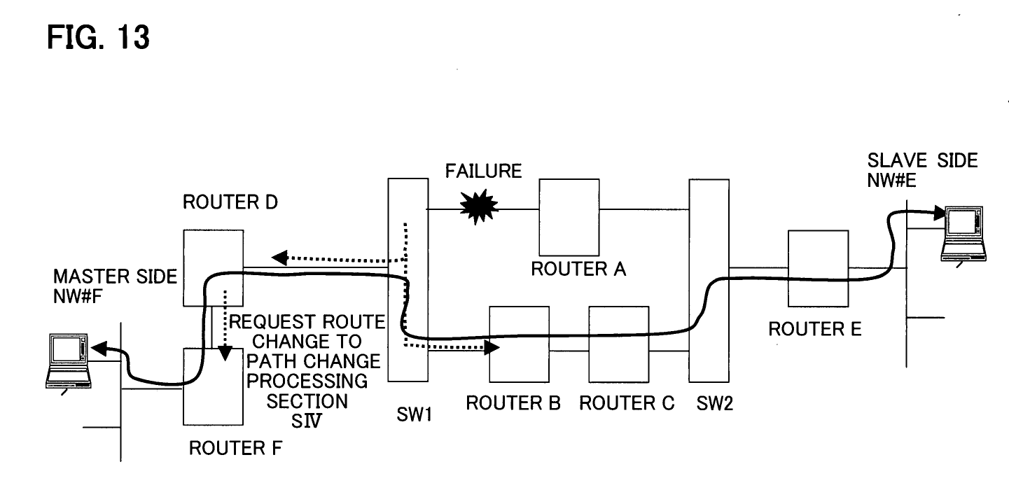

In the example described above, the switch device SW1 is connected to the network NW#D via the router device 20 (D) in one stage in FIG. 4. Another embodiment is the example shown in FIG. 13, where the switch device SW1 is connected to the network NW#F via another router device 20 (F) adjacent to the router device 20 (D).

As described above, when the information on the failure X is notified to the router device 20 (D), the path change request is sent from the router device 20 (D) to the path change processing section 200 of the adjacent router device 20 (F) by the conventional function (step SIV).

Therefore in the router device 20 (F), processing the same as the above description is performed. In other words, in FIG. 10, after the path change processing section 200 of the router device 20 (F) recognized that the line to the router device 20 (A) failed, NextHop in the routing table 220 of the router device 20 (F) is retrieved using the IP address of the router device 20 (A) as the retrieval condition (processing step P18), and corresponding routing information is deleted from the routing table 220 (processing step P19).

Here as a conventional function when the packet is relayed to the destination network NW, the label switching path (LSP) detection section 230 of the MPLS (Multi-Protocol Label Switching) of the router device 20 acquires the adjacent router device of the destination network NW and the label information attached by referring to the LSP path table 240, attaches the appropriate label, and sends the packet to the adjacent router device.

At this time the corresponding routing information is also notified to the routing detection processing section 250 of the path change processing section 200 of the router device F, and NextHop in the routing table 220 is retrieved, and the corresponding routing information is deleted from the routing table, in the adjacent routing device F as well, using the conventional function.

By this, the router device F can perform communication immediately by passing all the IP packets, which used to pass through the router device A for communication, through the detour path (path via the router device B and router device C).

After the path change processing section 200 of the router device F recognized that the line to the router A failed, NextHop in the LSP path table 240 of the router device F is retrieved using the IP address of the router device A as the retrieval condition (FIG. 10: processing step P20).

If a corresponding path information exists (processing step P21, YES), this is deleted from the LSP path table 240 (processing step P22).

At this time the path change processing section 200 of the router device F also notifies this label information to the LSP detection section 230, retrieves NextHop in the LSP path information table 240 (see FIG. 14(A)), and deletes the corresponding path information (router device D) from the LSP path information table using the conventional function.

Therefore the router device F can perform communication immediately by passing all the IP packets, which used to pass through the router device A, through the detour path (path via router device B and router device C).

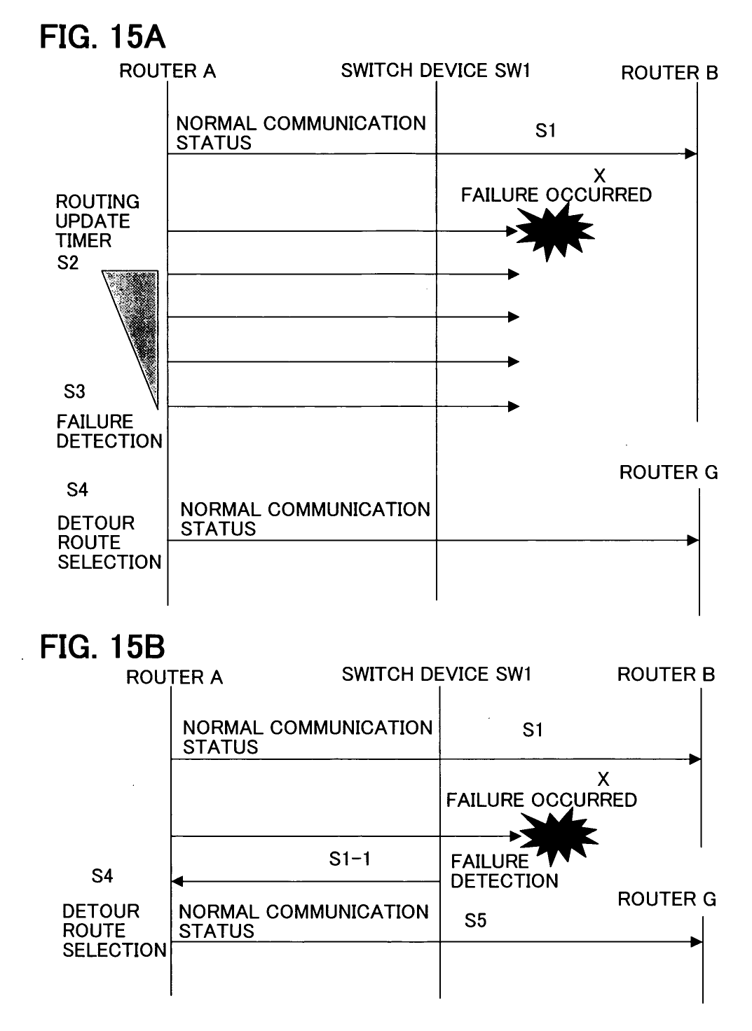

FIG. 15 is a diagram comparing the conventional path switching operation (FIG. 15A) and the path switching operation according to the present invention (FIG. 15B).

In FIG. 15A, if a failure X occurs when the router device A and the router device B are communicating via the switch device SW1 (S1), the router device A monitors the routing update timer (S2). The generation of the failure X is known by the router device A when the timer end counting (S3).

Then the detour route is selected (S4), and normal communication status starts using the route via another router device G (S5).

In the case of the method according to the present invention in FIG. 5B, on the other hand, if a failure X occurs when the router device A and the router device B are communicating via the switch device SW1 (S1), the failure is notified to the router device A by the switch device SW1 (S1-1).

Therefore the router A can immediately know the generation of the failure X, then the detour route is selected (S4), and normal communication status starts using the path via another router G (S5). By this, the path switching can be completed without waiting until the timer ends counting.

In the above embodiment, the protocol on the IP network is IPv4 as an example, but obviously IPv6 or a later version may be used as long as the protocol does not depart from the essential character of the invention.

### INDUSTRIAL APPLICABILITY

As described above according to the drawings, the present invention can provide a path switching system for a network having a detour path, that can dramatically decrease the time until the transfer path of the user data is switched to the detour path when a failure occurs to a system/line constituting the network.

1. A path switching system in a point-to-multi-point format IP network, using Ethernet where a path is set by a switch device and a plurality of relay devices adjacent to the switch device, wherein
the switch device comprises a notification processing section notifying information to specify a corresponding relay device to the plurality of other relay devices when a failure of an adjacent relay device or a line failure between adjacent relay devices is detected, and
the relay device comprises a path change processing section canceling information on the path that passes through the relay device detected to have a failure, within the information notified by the notification processing section of the relay device.

2. The path switching system according to claim 1, wherein the notification processing section of the switch device notifies the failure to a plurality of adjacent relay devices using broadcast packets.

3. The path switching system according to claim 1, wherein the path change processing section of the relay device cancels only information on the path that passes through a specific relay device notified by the notification processing section of the switch device within a plurality of path information dynamically recognized/acquired by the dynamic routing protocol.

4. The path switching system according to claim 1, wherein the switch device uses a MAC address of a relay device as the information to specify the corresponding relay device when a failure of an adjacent relay device or a line failure between adjacent relay devices is detected, and the path change processing section of the relay device searches a table that indicates the correspondence of the MAC address and IP address using the MAC address, and recognizes the IP address of the corresponding relay device.

5. The path switching system according to claim 1, wherein the relay device further comprises a label switching path detection section and a routing detection section, and when only information on the path that passes through a specific relay device notified by the notification processing section of the switch device is canceled out of a plurality of path information dynamically recognized/acquired by the dynamic routing protocol, the path change processing section of the relay device sends notice to the label switching path detection section and the routing detection section, and cancels the information on paths to a plurality of adjacent relay devices out of the label switching path information and the routing table mapped by the label switching path detection section and the routing detection section respectively.
